(19) United States
(12) Patent Application Publication
(10) Pub. No.: US 2020/0291703 A1
(43) Pub. Date: Sep. 17, 2020

(54) LOCKING HINGE ASSEMBLY

(71) Applicant: GM Global Technology Operations LLC, Detroit, MI (US)

(72) Inventors: Jairo Abraham Cruz Lopez, Cuautitlan Izcalli (MX); Andres Omar Alvarez Lopez, Toluca (MX); Carlos Fernando Rendon Martinez, Toluca (MX); Sinuhe Barajas Rios, Toluca (MX)

(21) Appl. No.: 16/298,641

(22) Filed: Mar. 11, 2019

(51) Int. Cl. E05D 7/12; E05D 7/10

(52) U.S. Cl. CPC E05D 7/121; E05Y 2900/50; E05D 7/10

(57) ABSTRACT

A hinge assembly for an automobile that is adapted to attach a first component to a second component, wherein the first component pivots about an axis relative to the first component, comprises a base plate adapted to be mounted to the first component, a hinge support adapted to be mounted to the second component and adapted to support the base plate and first component on the second component, a hinge hook extending from the base plate and adapted to removably and rotatably engage the hinge support, and a locking mechanism mounted onto the hinge assembly and adapted to selectively lock the hinge hook in rotational engagement with the hinge support.

### INTRODUCTION

The present disclosure relates to a hinge assembly for attaching components. Hinge assemblies are common in all industries, particularly automotive and are used for a variety of applications, such as attaching trunk lids and hoods to automobiles. Hinges must be robust enough to withstand collisions and still maintain their connection. Hinges must also be easy to assemble and cost effective.

Hinges are used on covers, doors, suitcases, vehicles, and the like, to provide a way to access an object without having to remove the cover, door, etc. Hinges come in a variety of designs and styles including door hinges, continuous hinges, internal and external hinges, and the like. Generally, hinges include two components with a pin or rod that connects the two hinge components together allowing the two hinge components to rotate relative to each other about the axis of the pin or rod. For example, to separate a door from its molding, the hinge pins must be removed in order to separate the two hinge components.

In another example, many automotive repairs require a mechanic to remove the hood of the car to gain access to the engine. Sometimes the engine must even be removed for service. Removing and reinstalling the hood of a car has been a difficult procedure at best. Typically, the hood is bolted onto hinges, which in turn are bolted somewhere into the engine compartment. As soon the bolts are loosened, the hood tends to fall over. In practice, one or two mechanics were required to hold the hood up while a mechanic removes the bolts connecting the hood to the car. The most time consuming and difficult aspect is the time spent remounting the hood. It is difficult to hold the hood in place and get the bolts or mounting hardware started. There is also difficulty in aligning the hood to the body parts so as not to damage the hood or other parts, or paint, upon initial closure of the hood. Lastly, getting the final fit and alignment correct requires numerous iterations of adjustments and possibly shimming to obtain the proper fit. The result is that substantial mechanic time and expense is required to remove and then to replace the hood.

Therefore, what is needed is a detachable hinge system that securely holds the door, cover, or vehicle hood when the hinge system is closed. What is also needed is a detachable hinge system that operates as a hinge when closed, but can be released when opened without removing any hinge bolts, hinge screws, or hinge pins.

### SUMMARY

According to several aspects of the present disclosure, a hinge assembly for an automobile adapted to attach a first component to a second component, wherein the first component pivots about an axis relative to the first component, comprises a base plate adapted to be mounted to the first component, a hinge support adapted to be mounted to the second component and adapted to support the base plate and first component on the second component, a hinge hook extending from the base plate and adapted to removably and rotatably engage the hinge support, and a locking mechanism mounted onto the hinge assembly and adapted to selectively lock the hinge hook in rotational engagement with the hinge support.

According to another aspect of the present disclosure, the hinge support includes a cylindrical shaft having a longitudinal axis and the hinge hook rotatably engages the cylindrical shaft of the hinge support, further wherein the hinge plate and the first component is rotatable relative to the hinge support and second component about the longitudinal axis of the cylindrical shaft.

According to another aspect of the present disclosure, the hinge hook defines a c-shaped cylindrical inner surface and the cylindrical shaft defines a cylindrical outer surface, wherein the cylindrical inner surface of the hinge hook defines a longitudinal axis that is co-axial with the longitudinal axis of the cylindrical shaft.

According to another aspect of the present disclosure, the cylindrical inner surface of the hinge hook partially encircles the cylindrical shaft when the hinge hook is engaged with the cylindrical shaft.

According to another aspect of the present disclosure, the the cylindrical inner surface of the hinge hook encircles less than half of a circumference of the cylindrical shaft of the hinge support.

According to another aspect of the present disclosure, the locking mechanism is rotatable between a first position, wherein the cylindrical shaft can be inserted into and removed from the hinge hook, and a second position, wherein the locking mechanism locks the cylindrical shaft in engagement with the hinge hook.

According to another aspect of the present disclosure, the locking mechanism defines a cylindrical inner surface, wherein when the locking mechanism is rotated to the second position the cylindrical inner surface of the locking mechanism further encircles the cylindrical shaft of the hinge support to lock the cylindrical shaft in engagement with the hinge hook.

According to another aspect of the present disclosure, when the locking mechanism is rotated to the second position, the cylindrical inner surface of the hinge hook and the cylindrical inner surface of the locking mechanism encircle more than half of a circumference of the cylindrical shaft of the hinge support.

According to another aspect of the present disclosure, the locking mechanism rotates about the longitudinal axis of the cylindrical shaft of the hinge support.

According to another aspect of the present disclosure, the hinge hook further includes a cylindrical outer surface, wherein the cylindrical inner surface of the locking mechanism is supported on the cylindrical outer surface of the hinge hook.

According to another aspect of the present disclosure, the hinge hook further comprises a flat portion extending tangentially from the cylindrical outer surface of the hinge hook, wherein when the locking mechanism is rotated from the second position to the first position, the cylindrical inner surface of the locking mechanism contacts the flat portion of the hinge hook to prevent the locking mechanism from rotating past the first position.

According to another aspect of the present disclosure, the locking mechanism includes a tang adapted to allow the locking mechanism to be manually moved from the first position to the second position.

According to another aspect of the present disclosure, the locking mechanism is rotated from the second position back to the first position, the tang is adapted to contact the base plate to prevent the locking mechanism from rotating beyond the first position.

According to another aspect of the present disclosure, the locking mechanism includes a detent to provide resistance to keep the locking mechanism in one of the first and second positions.

According to another aspect of the present disclosure, the base plate includes a first notch and a second notch and the locking mechanism includes a first extension and a second extension, wherein when the locking mechanism is in the first position the first extension is positioned within the first notch and the second extension is positioned within the second notch, and when the locking mechanism is in the second position, the first extension is positioned within the second notch.

According to another aspect of the present disclosure, the base plate further comprises a slot formed therein and the locking mechanism is adapted to rotate within the slot between the first position and the second position.

According to another aspect of the present disclosure, the slot includes a first side wall and a second side wall, further wherein the first and second notches are formed within at least one of the side walls and the first and second extensions extend laterally from at least one side wall of the locking mechanism.

According to another aspect of the present disclosure, the locking mechanism further comprises a stop, wherein when the locking mechanism is rotated from the first position to the second position the stop contacts the base plate to prevent the locking mechanism from rotating beyond the second position.

According to another aspect of the present disclosure, the base plate includes a plurality of bolt holes adapted to allow the base plate to be mounted onto the first component.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of the base plate for a hinge assembly for an automobile of the present disclosure according to an exemplary embodiment;

FIG. 2 is a perspective sectional view taken along line 2-2 of FIG. 1; and

FIG. 3 is a side sectional view taken along line 2-2 of FIG. 1.

### DETAILED DESCRIPTION

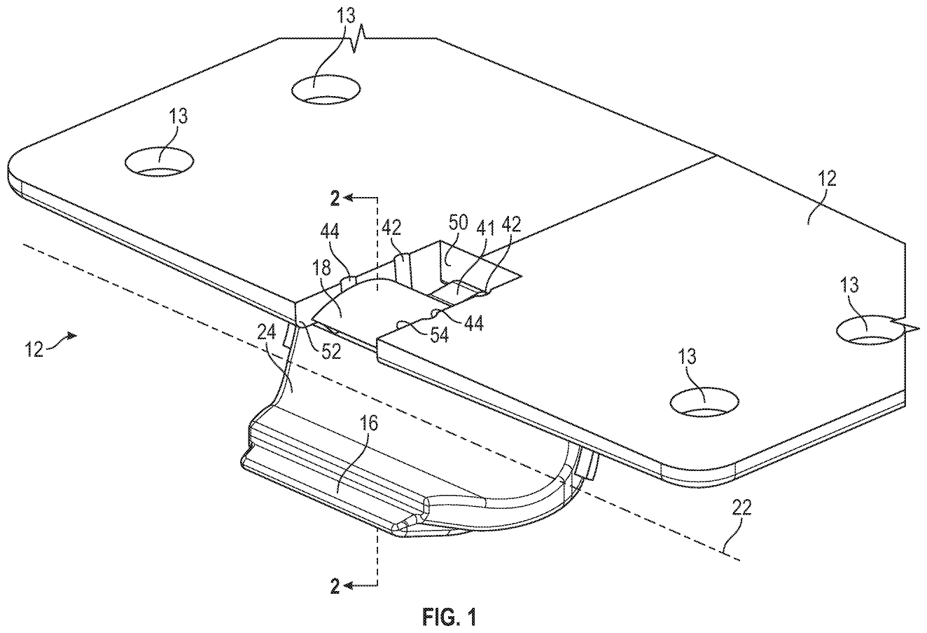

The following description is merely exemplary in nature and is not intended to limit the present disclosure, application, or uses. Referring to FIGS. 1, 2 and 3, a hinge assembly adapted to attach a first component to a second component is shown generally at 10. The hinge assembly 10 is adapted to attach a first component to a second component, wherein the first component pivots about an axis relative to the first component. The first and second components may be any two components that need to be connected to one another with a hinge. By way of a non-limiting example, the first component may be a hood for an automobile, and the second component may be the automobile, to which the hood is mounted. The hinge assembly 10 allows the hood to be mounted pivotally to the automobile. The hinge assembly 10 would allow the hood of the automobile to be pivoted between and open and closed position.

The hinge assembly 10 includes a base plate 12 that is adapted to be mounted onto the first component, and a hinge support 14 that is adapted to be mounted to the second component. The hinge support 14 supports the base plate 12 and the first component on the second component. The base plate 12 includes a plurality of bolt holes 13 to allow the base plate 12 to be mounted onto a first component. A hinge hook 16 extends from the base plate 12. The hinge hook 16 is adapted to removably and rotatably engage the hinge support 14. A locking mechanism 18 is mounted onto the hinge assembly 10. The locking mechanism 18 selectively locks the hinge hook 16 in rotational engagement with the hinge support 14. When the hinge support 14 is engaged with the hinge hook 16 and secured therein by the locking mechanism 18, the base plate 12 is rotatably supported on the hinge support 14 to pivotally support the first component on the second component.

The hinge support 14 includes a cylindrical shaft 20 having a longitudinal axis 22 and the hinge hook 16 rotatably engages the cylindrical shaft 20 of the hinge support 14. The base plate 12 and the first component are rotatable relative to the hinge support 14 and second component about the longitudinal axis 22 of the cylindrical shaft 20.

The hinge hook 16 defines a c-shaped cylindrical inner surface 24 and the cylindrical shaft 20 defines a cylindrical outer surface 26. The cylindrical inner surface 24 of the hinge hook 16 defines a longitudinal axis 28 that is co-axial with the longitudinal axis 22 of the cylindrical shaft 20. A radius 28 of the cylindrical inner surface 24 of the hinge hook 16 is larger than a radius 30 of the cylindrical shaft 20. Preferably, the radius 24 of the cylindrical inner surface 24 of the hinge hook 16 is only slightly larger than the radius 30 of the cylindrical shaft 20, whereby the cylindrical shaft 20 fits within the c-shaped cylindrical inner surface 24 of the hinge hook 16 with minimal relative movement, but with sufficient clearance to allow the cylindrical shaft 20 to freely rotate within the c-shaped inner cylindrical surface 24 of the hinge hook 16.

When the cylindrical shaft 20 of the hinge support 14 is engaged with the hinge hook 16, the cylindrical inner surface 24 of the hinge hook 16 partially encircles the cylindrical shaft 20. To allow the cylindrical shaft 20 of the hinge support 14 to be inserted and removed from the hinge hook 16, the cylindrical inner surface 24 of the hinge hook 16 extends less than half way around the circumference of the cylindrical shaft 20. The cylindrical inner surface 24 of the hinge hook 16 extends circumferentially around the cylindrical shaft less than 180 degrees, as shown at 25 in FIG. 3.

The locking mechanism 18 rotates about the longitudinal axis 22 of the cylindrical shaft 20 of the hinge support 14. The locking mechanism 18 is rotatable between a first position 32, as shown in phantom in FIG. 3, wherein the cylindrical shafts 20 can be inserted into and removed from the hinge hook 16, and a second position 34, as shown in FIG. 3, wherein the locking mechanism 18 locks the cylindrical shaft 20 in engagement with the hinge hook 16.

The locking mechanism 18 defines a cylindrical inner surface 36, wherein when the locking mechanism 18 is rotated to the second position 34 the cylindrical inner surface 36 of the locking mechanism 18 further encircles the cylindrical shaft 20 of the hinge support 14 to lock the cylindrical shaft 20 in engagement with the hinge hook 16. When the locking mechanism 18 is rotated to the second position 34, the cylindrical inner surface 24 of the hinge hook 16 in combination with the cylindrical inner surface 36 of the locking mechanism 18 encircles more than half of the circumference of the cylindrical shaft 20 of the hinge support 14. The cylindrical inner surface 24 of the hinge hook 16 in combination with the cylindrical inner surface 36 of the locking mechanism 18 extends circumferentially around the cylindrical shaft 20 more than 180 degrees, as shown at 27 in FIG. 3. When the locking mechanism 18 is rotated to the second position 34, the cylindrical inner surface 24 of the hinge hook 16 in combination with the cylindrical inner surface 36 of the locking mechanism 18 prevent the cylindrical shaft 20 from dis-engaging from the hinge hook 16.

The hinge hook 16 includes a cylindrical outer surface 38. The cylindrical inner surface 36 of the locking mechanism 18 is supported on the cylindrical outer surface 38 of the hinge hook 16. The hinge hook 16 further includes a flat portion 40 extending tangentially from the cylindrical outer surface 38 of the hinge hook 16. When the locking mechanism 18 is rotated from the second position 34 to the first position 32, the cylindrical inner surface 36 of the locking mechanism 18 contacts the flat portion 40 of the hinge hook 16 to prevent the locking mechanism 18 from rotating past the first position 32.

The locking mechanism 18 includes a tang 41 adapted to allow the locking mechanism 18 to be manually moved from the first position 32 to the second position 34. In addition to, or as an alternative to the flat portion 40 of the cylindrical outer surface 38 of the hinge hook, the tang 41 may also provide a stop for the locking mechanism 18. When the locking mechanism 18 is rotated from the second position 34 back to the first position 32, the tang 41 can be adapted to contact the base plate 12 to prevent the locking mechanism 18 from rotating beyond the first position 32.

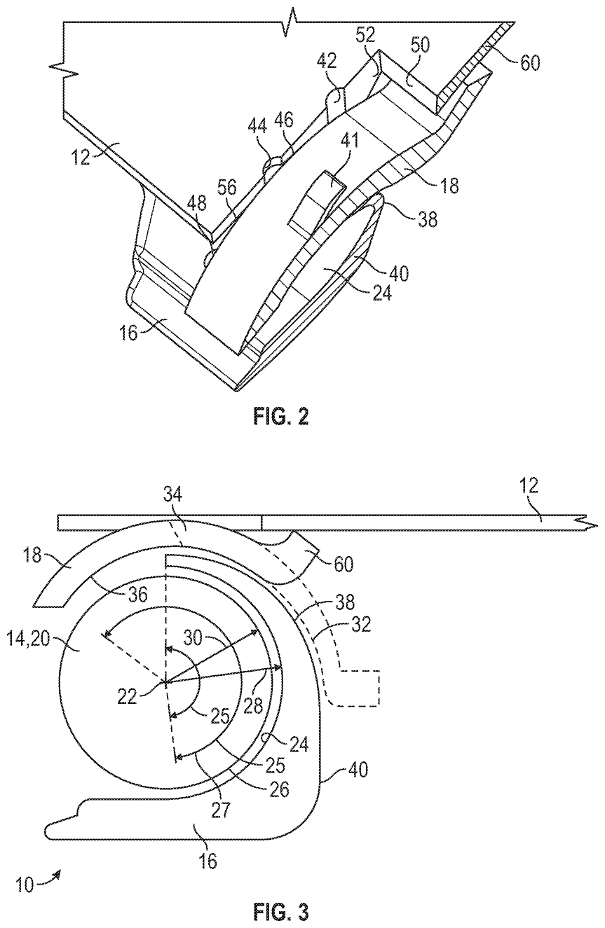

Referring to FIG. 2, the locking mechanism 18 includes a detent to provide resistance to keep the locking mechanism 18 in one of the first and second positions 32, 34. The base plate 12 includes a first notch 42 and a second notch 44 and the locking mechanism 18 includes a first extension 46 and a second extension 48. When the locking mechanism 18 is in the first position 32 the first extension 46 is positioned within the first notch 42 and the second extension 48 is positioned within the second notch 44. When the locking mechanism 18 is in the second position 34, the first extension 46 is positioned within the second notch 44. The engagement of the first and second extensions 46, 48 in the first and second notches 42, 44 provides frictional resistance to keep the locking mechanism 18 in the first or second positions 32, 34. The frictional resistance will not prevent manual engagement or dis-engagement of the locking mechanism 18, but will maintain the position of the locking mechanism 18 under normal conditions.

The base plate 12 of the hinge assembly 10 includes a slot 50 formed therein. The locking mechanism 18 rotates within the slot 50 between the first position 32 and the second position 34. The slot 50 includes a first side wall 52 and a second side wall 54. The first and second notches 42, 44 are formed within at least one of the side walls 52, 54 and the first and second extensions 46, 48 extend laterally from at least one of the side walls 56, 58 of the locking mechanism 18. In one possible non-limiting example, a first and second notch 42, 44 are formed in each of the first and second side walls 52, 54, and first and second extensions 46, 48 extend laterally from each of the first and second side walls 56, 58 of the locking mechanism 18.

The locking mechanism 18 includes a stop 60 extending from a distal end. When the locking mechanism 18 is rotated from the first position 32 to the second position 34 the stop 60 contacts the base plate 12 to prevent the locking mechanism 18 from rotating beyond the second position 34.

A hinge assembly of the present disclosure offers several advantages. The hinge assembly of the present invention provides a robust hinge that can withstand impacts and wear and tear associated with automobiles. The hinge assembly of the present invention further provides re-usable connectivity that allows the hinged component to be removed without removing bolts or pins and allows re-assembly without the need to re-align the component.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A hinge assembly for an automobile, adapted to attach a first component to a second component, wherein the first component pivots about an axis relative to the first component, the hinge assembly comprising:
a base plate adapted to be mounted to the first component;
a hinge support adapted to be mounted to the second component and adapted to support the base plate and first component on the second component;
a hinge hook extending from the base plate, the hinge hook adapted to removably and rotatably engage the hinge support; and
a locking mechanism mounted onto the hinge assembly and adapted to selectively lock the hinge hook in rotational engagement with the hinge support.

2. The hinge assembly for an automobile of claim 1, wherein the hinge support includes a cylindrical shaft having a longitudinal axis and the hinge hook rotatably engages the cylindrical shaft of the hinge support, further wherein the hinge plate and the first component are rotatable relative to the hinge support and second component about the longitudinal axis of the cylindrical shaft.

3. The hinge assembly for an automobile of claim 2, wherein the hinge hook defines a c-shaped cylindrical inner surface and the cylindrical shaft defines a cylindrical outer surface, wherein the cylindrical inner surface of the hinge hook defines a longitudinal axis that is co-axial with the longitudinal axis of the cylindrical shaft.

4. The hinge assembly for an automobile of claim 3, wherein the cylindrical inner surface of the hinge hook partially encircles the cylindrical shaft when the hinge hook is engaged with the cylindrical shaft.

5. The hinge assembly for an automobile of claim 4, wherein the cylindrical inner surface of the hinge hook encircles less than half of a circumference of the cylindrical shaft of the hinge support.

6. The hinge assembly for an automobile of claim 4, wherein the locking mechanism is rotatable between a first position, wherein the cylindrical shaft can be inserted into and removed from the hinge hook, and a second position, wherein the locking mechanism locks the cylindrical shaft in engagement with the hinge hook.

7. The hinge assembly for an automobile of claim 6, wherein the locking mechanism defines a cylindrical inner surface, wherein when the locking mechanism is rotated to the second position the cylindrical inner surface of the locking mechanism further encircles the cylindrical shaft of the hinge support to lock the cylindrical shaft in engagement with the hinge hook.

8. The hinge assembly for an automobile of claim 7, wherein when the locking mechanism is rotated to the second position, the cylindrical inner surface of the hinge hook and the cylindrical inner surface of the locking mechanism encircle more than half of a circumference of the cylindrical shaft of the hinge support.

9. The hinge assembly for an automobile of claim 7, wherein the locking mechanism rotates about the longitudinal axis of the cylindrical shaft of the hinge support.

10. The hinge assembly for an automobile of claim 9, wherein the hinge hook further comprises a cylindrical outer surface, wherein the cylindrical inner surface of the locking mechanism is supported on the cylindrical outer surface of the hinge hook.

11. The hinge assembly for an automobile of claim 10, wherein the hinge hook further comprises a flat portion extending tangentially from the cylindrical outer surface of the hinge hook, wherein when the locking mechanism is rotated from the second position to the first position, the cylindrical inner surface of the locking mechanism contacts the flat portion of the hinge hook to prevent the locking mechanism from rotating past the first position.

12. The hinge assembly for an automobile of claim 10, wherein the locking mechanism includes a tang adapted to allow the locking mechanism to be manually moved from the first position to the second position.

13. The hinge assembly for an automobile of claim 12, wherein when the locking mechanism is rotated from the second position back to the first position, the tang is adapted to contact the base plate to prevent the locking mechanism from rotating beyond the first position.

14. The hinge assembly for an automobile of claim 6, wherein the locking mechanism includes a detent to provide resistance to keep the locking mechanism in one of the first and second positions.

15. The hinge assembly for an automobile of claim 14, wherein the base plate includes a first notch and a second notch and the locking mechanism includes a first extension and a second extension, wherein when the locking mechanism is in the first position the first extension is positioned within the first notch and the second extension is positioned within the second notch, and when the locking mechanism is in the second position, the first extension is positioned within the second notch.

16. The hinge assembly for an automobile of claim 15, wherein the base plate further comprises a slot formed therein, the locking mechanism adapted to rotate within the slot between the first position and the second position.

17. The hinge assembly for an automobile of claim 16, wherein the slot includes a first side wall and a second side wall, further wherein the first and second notches are formed within at least one of the side walls and the first and second extensions extend laterally from at least one side wall of the locking mechanism.

18. The hinge assembly for an automobile of claim 10, wherein the locking mechanism further comprises a stop, wherein when the locking mechanism is rotated from the first position to the second position the stop contacts the base plate to prevent the locking mechanism from rotating beyond the second position.

19. The hinge assembly for an automobile of claim 1, wherein the base plate includes a plurality of bolt holes adapted to allow the base plate to be mounted onto the first component.
